(19) United States
(12) Patent Application Publication
(10) Pub. No.: US 2015/0243252 A1
(43) Pub. Date: Aug. 27, 2015

(54) INFORMATION PROCESSING METHOD AND ELECTRONIC DEVICE

(71) Applicant: Lenovo (Beijing) Co., Ltd., Beijing (CN)

(72) Inventor: Yi Zhang, Beijing (CN)

(73) Assignee: Lenovo (Beijing) Co., Ltd., Beijing (CN)

(21) Appl. No.: 14/228,528

(22) Filed: Mar. 28, 2014

(30) Foreign Application Priority Data
Feb. 21, 2014 (CN) 201410060972.X

(51) Int. Cl. G09G 5/14

(52) U.S. Cl. CPC G09G 5/14; G09G 2340/0471

(57) ABSTRACT

An information processing method applied to a first electronic device is provided. The first electronic device includes a display unit, N files and M file objects are displayed on the display unit, the M file objects are displayed in M regions of the display unit respectively, and the N files correspond to the M file objects. The method includes: receiving a first operation by the first electronic device; judging whether the first operation conforms to a first preset condition; and displaying P files in the N files at one or more regions of the M regions corresponding to the P files, in the case that the first operation conforms to the first preset condition, where P is a positive integer less than or equal to N. Thus, an operation for arranging files is simplified.

This application claims the priority to Chinese Patent Application No. 201410060972.X, entitled “INFORMATION PROCESSING METHOD AND ELECTRONIC DEVICE”, filed with the Chinese Patent Office on Feb. 21, 2014, which is incorporated by reference in its entirety herein.

### FIELD

The disclosure relates to the field of electronic technology, and in particular to an information processing method and an electronic device.

### BACKGROUND

With the continuous development of the science and technology, electronic technology develops quickly, and types of electronic product are increased. People enjoy various conveniences brought by the development of the technology. Presently people may enjoy a comfortable life brought by the development of the technology by using various types of electronic devices. For example, some electronic devices, such as a smart phone and a tablet computer, have become an essential part of people's life. People may directly call, see a movie, listen to a music by using an electronic device such as a smart phone, thereby enhancing a contact with other people and obtaining a variety of information.

In order to watch a display screen of an electronic device by multiple users simultaneously, the most of electronic devices are designed with a large size display screen. For example, in conference, multiple users may perform operations on a tablet computer with a large size display screen simultaneously, which is convenient. In addition, the operations are relatively independent each other. Since the electronic device is placed horizontally, the user may perform a labor-saving operation on the horizontal desktop by touching the display screen.

However, in recent technical field, the following technical problems is found.

It is known, when multiple users use an electronic device with a large size screen simultaneously, if each user needs to display a file operated by the user in the display screen, multiple files may be displayed in the display screen. In addition, since each user performs different operation on the file. For example, different users move the required files to different positions, and various files in the display screen may be in a disorder display state. When a user needs to find out a file to be operated, the user may distinguish the files one by one, which takes a long time, hence the querying efficiency is low.

Therefore, there is a problem that an operation for arranging files is complicated in this field.

### SUMMARY

The embodiments of the disclosure provide an information processing method and an electronic device, to simplify an operation for arranging files in the prior art.

The embodiments of the disclosure provide an information processing method applied to a first electronic device, the first electronic device including a display unit, N files and M file objects being displayed at the display unit, the M file objects being respectively displayed in M regions of the display unit, the N files corresponding to the M file objects, the method including:

receiving a first operation by the first electronic device;

judging whether the first operation conforms to a first preset condition; and

displaying P files in the N files at one or more regions of the M regions corresponding to the P files, in the case that the first operation conforms to the first preset condition, wherein P is a positive integer less than or equal to N.

Optionally, the M file objects are obtained by receiving and caching storage locations of the M file objects in M second electronic devices by the first electronic device.

Optionally, before the displaying P files in the N files at one or more regions of the M regions corresponding to the P files, the N files are randomly displayed in respective regions of the display unit.

Optionally, the judging whether the first operation conforms to a first preset condition includes:

judging whether the first operation is a preset operation and whether the first electronic device receives the first operation in one of the M regions;

the displaying P files in the N files at one or more regions of the M regions corresponding to the P files in the case that the first operation conforms to the first preset condition includes:

displaying W files in the P files at a region corresponding to the Q-th file object, in the case that the first operation is the preset operation and the first electronic device receives the first operation at a region corresponding to the Q-th file object of the M file objects; wherein the W files correspond to the Q-th file object, W is a positive integer less than or equal to P, and Q is a positive integer less than or equal to M.

Optionally, the judging whether the first operation conforms to a first preset condition includes:

judging whether the first operation is a preset operation and whether the first electronic device receives the first operation at a first display region different from the M regions;

the displaying P files in the N files at one or more regions of the M regions corresponding to the P files, in the case that the first operation conforms to the first preset condition includes:

displaying the P files at the M regions corresponding to the P files respectively in the case that the first operation is the preset operation and the electronic device receives the first operation at the first display region different from the M regions, wherein P is equal to N.

Optionally, after the displaying P files in the N files at one or more regions of the M regions corresponding to the P files, the method further includes:

obtaining a second operation;

judging whether the second operation is an operation for dragging the P files to one or more second display regions different from the one or more regions of the M regions; and

moving the P files to display all of the P files at the second display regions, in the case that the second operation is the operation for dragging the P files to the one or more second display regions different from the one or more regions of the M regions.

Optionally, the first operation and the second operation are touch operations, an execution time for the first operation is a first period, an execution time for the second operation is a second period, each of the first period and the second period is successive, and during a whole period of the first period or the second period, an operator who performs the first operation or the second operation keeps touching the display unit.

The disclosure further provides an electronic device, including:

a display unit configured to display N files and M file objects, wherein the M file objects are respectively displayed in M regions of the display unit, the N files correspond to the M file objects;

a receiving unit configured to receive a first operation by the electronic device;

a judging unit configured to judge whether the first operation conforms to a first preset condition; and

a processing unit configured to display P files in the N files at one or more regions of the M regions corresponding to the P files in the case that the first operation conforms to the first preset condition; wherein P is a positive integer less than or equal to N.

Optionally, the M file objects are obtained by receiving and caching storage locations of the M file objects in M second electronic devices by the first electronic device.

Optionally, before the processing unit displays the P files in the N files at one or more regions of the M regions corresponding to the P files, the N files are randomly displayed at respective regions on the display unit.

Optionally, the judging unit is configured to:

judge whether the first operation is a preset operation and whether the electronic device receives the first operation at one of the M regions;

the processing unit is configured to:

display W files in the P files at a region corresponding to the Q-th file object, in the case that the first operation is the preset operation and the first electronic device receives the first operation at a region corresponding to the Q-th file object of the M file objects; wherein the W files correspond to the Q-th file object, W is a positive integer less than or equal to P, and Q is a positive integer less than or equal to M.

Optionally, the judging unit is configured to:

judge whether the first operation is a preset operation and whether the electronic device receives the first operation at a first display region different from the M regions;

the processing unit is configured to:

display the P files at the M regions corresponding to the P files respectively, in the case that the first operation is the preset operation and the electronic device receives the first operation at the first display region different from the M regions, wherein P is equal to N.

Optionally, the receiving unit is further configured to:

obtain a second operation;

the judging unit is further configured to:

judge whether the second operation is an operation for dragging the P files to one or more second display regions different from the one or more regions of the M regions; and

the processing unit is further configured to:

move the P files to display all of the P files at the second display regions, in the case that the second operation is the operation for dragging the P files to the one or more second display regions different from the one or more regions of the M regions.

Optionally, the first operation and the second operation are touch operations, an execution time for the first operation is a first period, an execution time for the second operation is a second period, each of the first period and the second period is successive, and during a whole period of the first period or the second period, an operator who performs the first operation or the second operation keeps touching the display unit all the time.

One or more technical solutions provided by the embodiments of the disclosure at least have the following technical effects or advantages.

In an embodiment of the disclosure, N files and M file objects are displayed on the display unit. The first electronic device receives a first operation of a user and judges whether the first operation conforms to a first preset condition. In the case that the first operation conforms to the first preset condition, P files in the N files are displayed in one or more regions of the M regions corresponding to the P files. For example, 6 files and 2 file objects are displayed on the display unit, where 4 files correspond to one of the 2 file objects, and another 2 files correspond to the other file object. In the case that the first operation conforms to the first preset condition, 4 files may be adjusted to a region where the corresponding file object is located according to the first preset condition; another 2 files are adjusted to the region where the corresponding file object is located; or all the 6 files are adjusted to the regions where the corresponding file objects are located, respectively. With this method, the operation for arranging files are simplified, steps of the operation for arranging files by a user are reduced, thereby improving operational efficiency and user experience.

### BRIEF DESCRIPTION OF THE DRAWINGS

FIG. 1 is a flow chart of an information processing method according to an embodiment of the disclosure;

FIG. 2A-2E are schematic diagrams of a process for arranging files according to an embodiment of the disclosure;

FIG. 3A-3C are schematic diagrams of a process for arranging files according to another embodiment of the disclosure; and

FIG. 4 is a functional block diagram of an electronic device according to an embodiment of the disclosure.

### DETAILED DESCRIPTION OF EMBODIMENTS

The embodiments of the disclosure provides an information processing method and an electronic device, to simplify an operation for arranging files, reduce steps of the operation for arranging files by a user, and improve operational efficiency and user experience.

In order to solve the technical problem described above, the general idea of the technical solutions in the embodiments of the disclosure is as follows.

In an embodiment of the disclosure, N files and M file objects are displayed on a display unit. A first electronic device receives a first operation from a user, and judges whether the first operation conforms to a first preset condition. In the case that the first operation conforms to the first preset condition, P files in the N files are displayed in one or more regions of M regions corresponding to the P files. In this way, an operation for arranging files are simplified, steps of the operation for arranging files by a user is reduced, thereby improving operational efficiency and user experience.

In order to better understand the technical solutions described above, the main principle, specific implementing ways and the beneficial effect of the technical solutions according to the embodiments of the disclosure will be clarified in detail in combination with the accompanying drawings hereinafter.

### First Embodiment

An embodiment of the disclosure provides an information processing method, which is applied to a first electronic device. The first electronic device may be for example a traditional tablet computer, a large size tablet computer or other electronic devices supporting multi-user and multi-direction operation. The first electronic device includes one display unit, N files and M file objects are displayed on the display unit. M file objects are respectively displayed in M regions of the display unit, and N files correspond to M file objects.

N files may be image files, audio files, video files, game applications and so on. N files correspond to M file objects. M file objects may be folders such as a picture folder, which contains the corresponding picture files. Furthermore, M file objects may also be audio folders, video folders, and game application folders. M file objects may also be navigation menu items. A folder may be accessed by clicking a menu item, to perform an operation on the files.

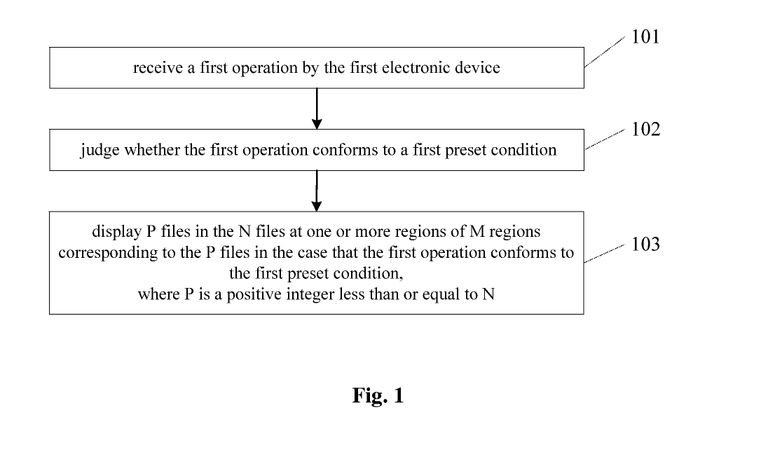

Next, reference is made to FIG. 1 which is a flow chart of an information processing method according to the embodiment. The method includes steps 101-103.

Step 101: receiving a first operation by a first electronic device.

Step 102: judging whether the first operation conforms to a first preset condition.

Step 103: displaying P files in the N files at one or more regions of M regions corresponding to the P files in the case that the first operation conforms to the first preset condition, where P is a positive integer less than or equal to N.

Optionally, in the embodiment of the disclosure, the M file objects are obtained by receiving and caching storage locations of the M file objects in M second electronic devices by the first electronic device. The second electronic device may be connected with the first electronic device via a data cable, WIFI, Bluetooth, and may also be connected with the first electronic device by a radio frequency tag. File objects are stored in the second electronic device. After the second electronic device is connected with the first electronic device, the first electronic device receives a storage position of the file object in the second electronic device and stores the file object in a cache of the first electronic device. When the file object needs to be called, the first electronic device directly reads the file object from the cache. When having some local file objects, the first electronic device may also store the local file objects in the cache, so as to facilitate the first electronic device to directly call theses file objects from the cache.

In step 101, the first operation may be an operation of clicking a certain button by the user. The button may be an entity button and may also be an icon button on the display unit. The first operation may also be successive clicking operations on the display unit by the user or a sliding operation on the display unit, which will not be limited by the disclosure. The step of receiving the first operation by the first electronic device may include: receiving a first touch operation of the user by the first electronic device via a touch display unit, and may include: detecting a sliding gesture of the user in the air by the first electronic device via infrared.

After receiving the first operation, the first electronic device performs step 102, i.e., judging whether the first operation conforms to a first preset condition.

According to different first preset conditions, the technical solutions of the disclosure are clarified from three aspects.

(1) The judging whether the first operation conforms to a first preset condition may include: judging whether the first operation is a preset operation and whether the first electronic device receives the first operation in one of the M regions.

In the specific implementing process, the preset operation may be a double click operation of the user on the display unit, an operation in which the user draws a circle in a clockwise direction on the touch display unit with fingers, or an operation in which the user long presses the touch display unit by an operator, which will not be limited by the disclosure. In the case that the first operation is the preset operation and the first electronic device receives the first operation in a region of the M regions where a certain file object is located, the step 103 is performed, i.e., P files in the N files is displayed at one or more regions of the M regions corresponding to the P files, in the case that the first operation conforms to the first preset condition. P is a positive integer less than or equal to N.

In step 103, the displaying P files in the N files at one or more regions of the M regions corresponding to the P files may include: displaying W files in the P files at the region corresponding to the Q-th file object, in the case that the first operation is a preset operation and the first electronic device receives the first operation in a region corresponding to the Q-th file object of the M file objects. W files correspond to the Q-th file object, W is a positive integer less than or equal to P and Q is a positive integer less than or equal to M.

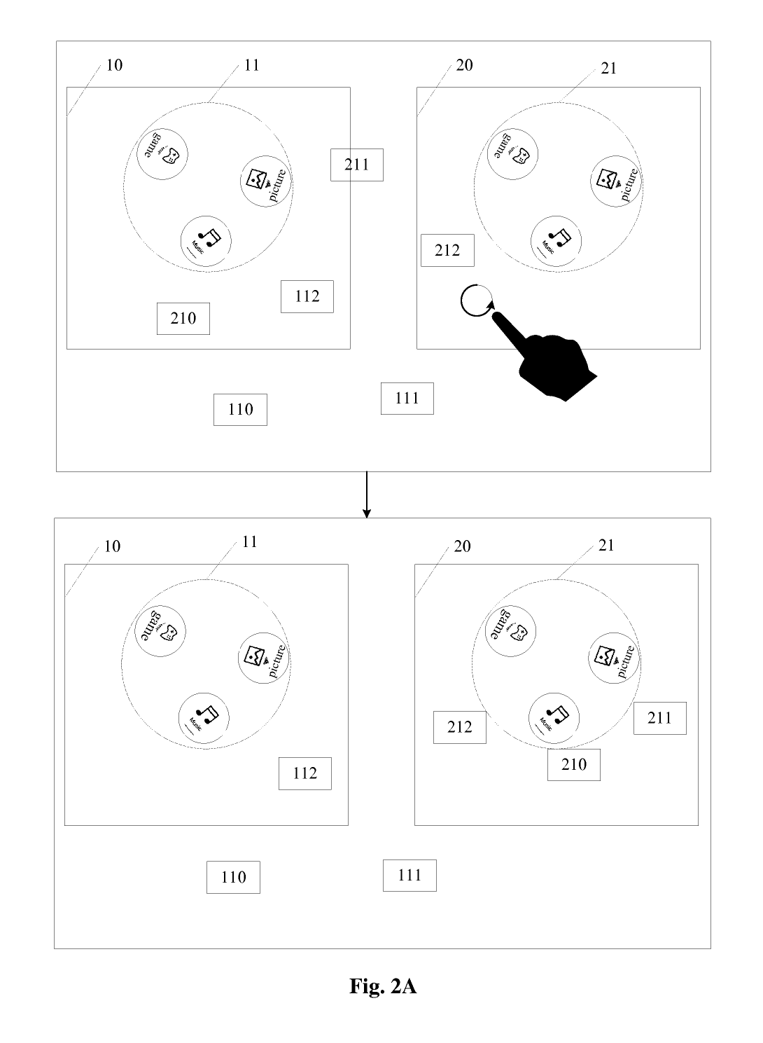

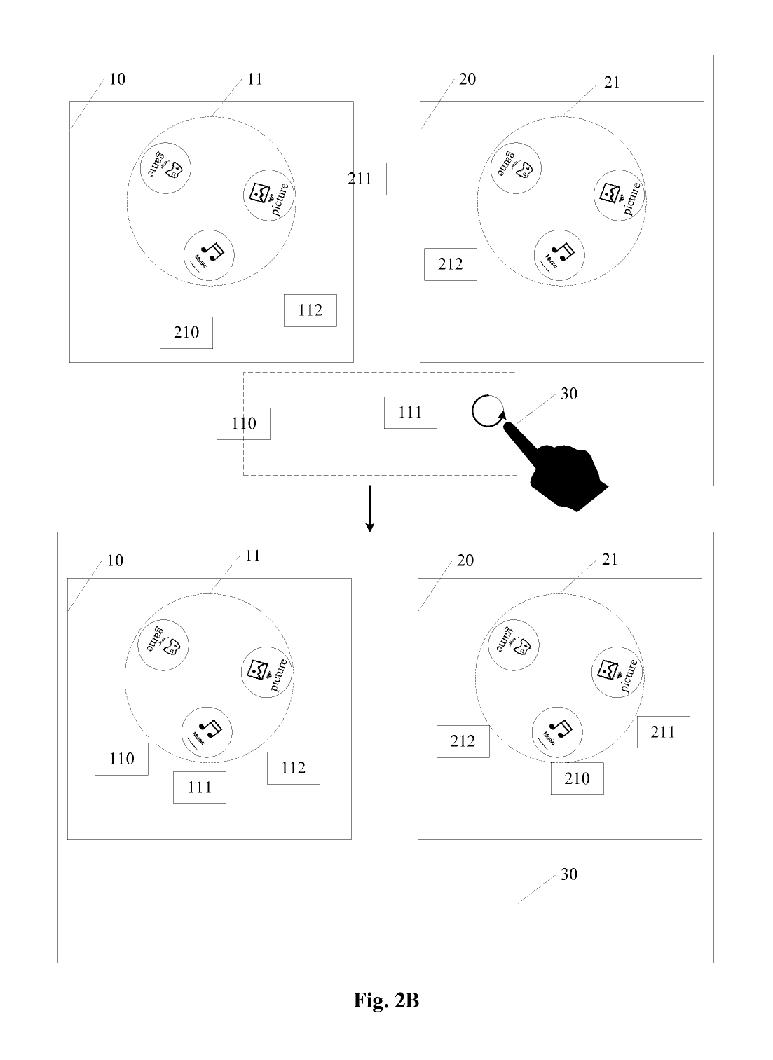

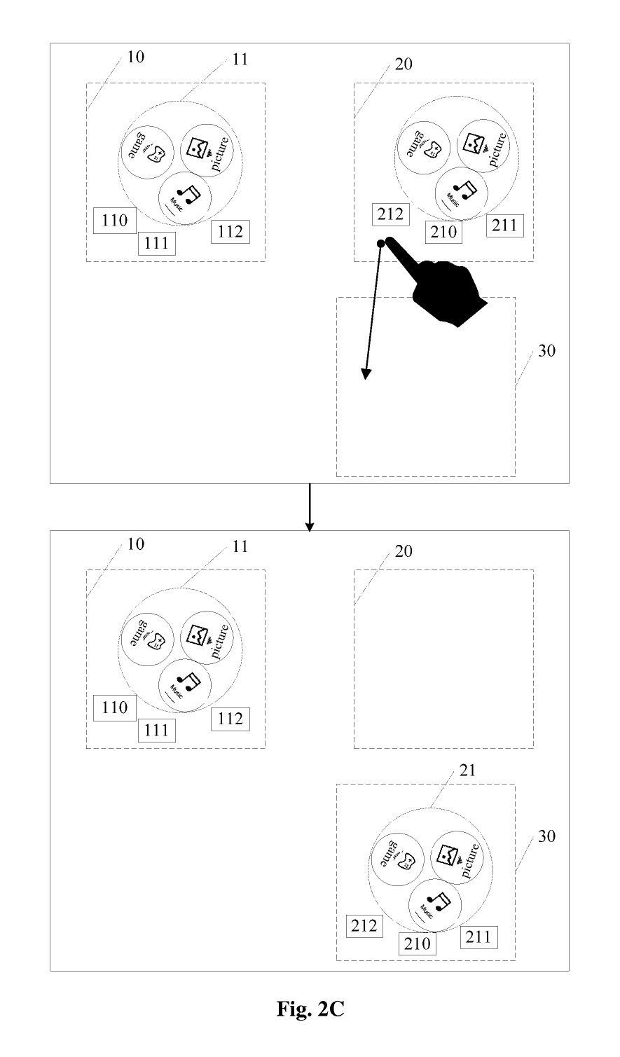

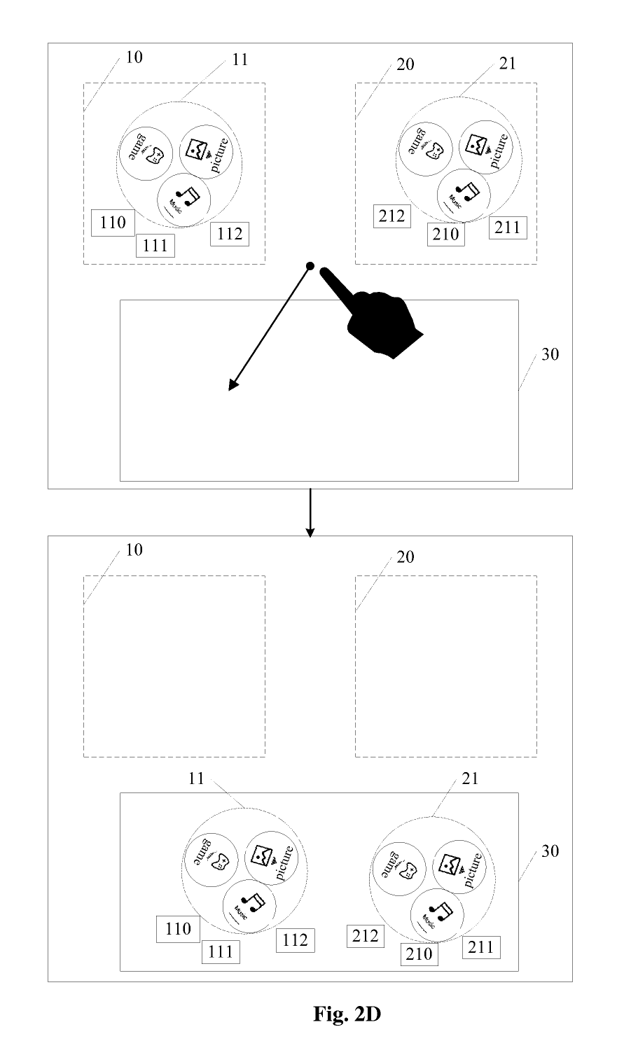

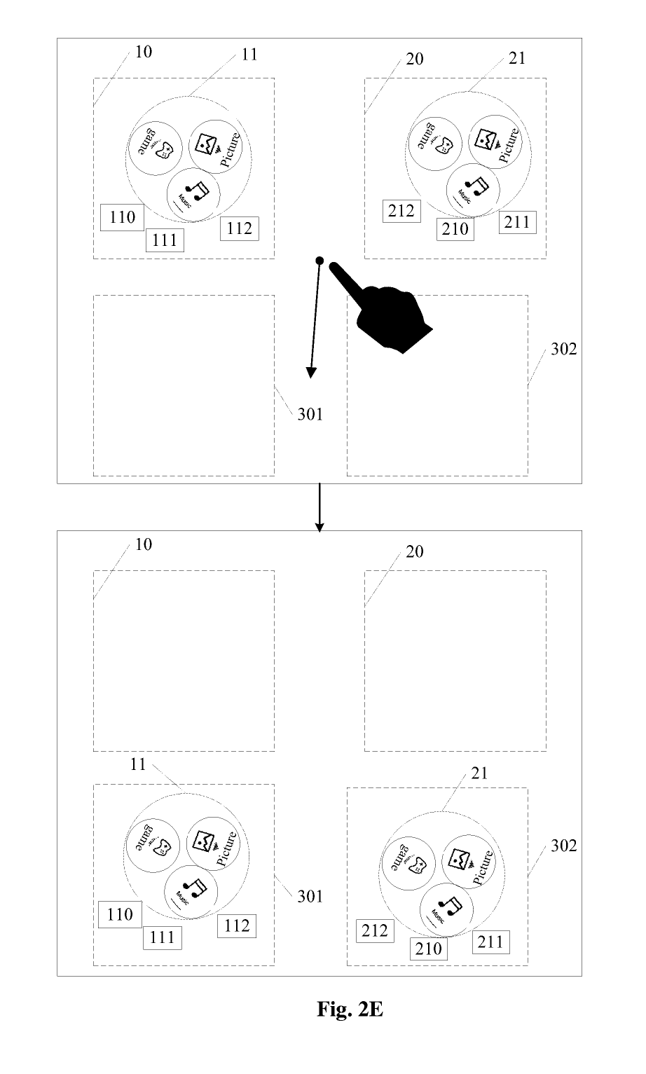

In the specific implementation, when the Q-th second electronic device is connected with the first electronic device, the Q-th file object is a navigation menu or a folder corresponding to the W files in the second electronic device. For example, referring to FIG. 2A, the first electronic device is connected with the second electronic device, and two navigation menus are displayed on the first electronic device. A navigation menu 11 in a region 10 is a navigation menu for the first electronic device, files 110, 111, 112 are files in the first electronic device. A navigation menu 21 in a region 20 is a navigation menu for the second electronic device, files 210, 211, 212 are files in the second electronic device. After the user makes a preset operation in the region 20, for example drawing a circle, the first electronic device adjusts display positions of files 210, 211, 212 to the region 20. The adjusted position for each file is show in FIG. 2A.

(2) The judging whether the first operation conforms to a first preset operation may include: judging whether the first operation is a preset operation and whether the first electronic device receives the first operation at a first display region different from the M regions.

In the case that the first operation is the preset operation and the first electronic device receives the first operation at the first display region different from the M regions, the step 103 is performed, i.e., P files in the N files is displayed at one ore more regions of the M regions corresponding to the P files, in the case that the first operation conforms to the first preset condition, where P is a positive integer less than or equal to N.

In step 103, the displaying P files in the N files at one or more regions of the M regions corresponding to the P files, in the case that the first operation conforms to the first preset condition may include: displaying the P files at the M regions corresponding to the P files respectively in the case that the first operation is the preset operation and the electronic device receives the first operation at the first display region different from the M regions, where P is equal to N.

For example, referring to FIG. 2B, the first electronic device is connected with the second electronic device, and two navigation menus are displayed on the first electronic device. A navigation menu 11 in a region 10 is a navigation menu for the first electronic device, files 110, 111, 112 are files in the first electronic device. A navigation menu 21 in a region 20 is a navigation menu for the second electronic device, files 210, 211, 212 are files in the second electronic device. Both the navigation menu 11 and the navigation menu 21 are not located in a first display region 30. After the user makes a preset operation on the region 30, for example drawing a circle, the first electronic device adjusts display positions for the files 110, 111, 112, 210, 211, 212, such that the files 110, 111, 112 are all displayed in the region 10, and the files 210, 211, 212 are all displayed in the region 20. The adjusted position for each file is shown in FIG. 2B.

(3) A number pad is also displayed on the first electronic device, and M+1 natural numbers from 0 to M are displayed in the number pad. M natural numbers in the M+1 natural numbers are in one-to-one correspondence with M file objects respectively, and the remaining natural number corresponds to all the file objects. The judging whether the first operation conforms to a first preset condition may include: judging whether the user clicks a number on the number pad.

In the case that the user clicks a number on the number pad, the step 103 is performed, i.e., P files in a file object corresponding to the number is displayed at a region for the file object, where P is a positive integer less than or equal to N.

In the specific implementation, the number pad may be a dial pad or a number plate, which will not limited by the disclosure. Number 0 corresponds to an adjustment of display positions for all the files. When the number 0 is clicked, all the files are respectively displayed at regions corresponding to the M file objects. Number 1 corresponds to an adjustment of display positions for files of the first electronic device. When the number 1 is clicked, the locations of files of the first electronic device are adjusted to a region where file objects corresponding to the first electronic device are located. Number 2 corresponds to an adjustment of display positions for files of the first second electronic device. When the number 2 is clicked, the locations of files of the first second electronic device are adjusted to a region where file objects corresponding to the first second electronic device are located. . . . , number M+1 corresponds to an adjustment of display positions for files of the M-th second electronic device. When the number M+1 is clicked, the locations of files of the M-th second electronic device are adjusted to a region where file objects correspond to the M-th second electronic device are located.

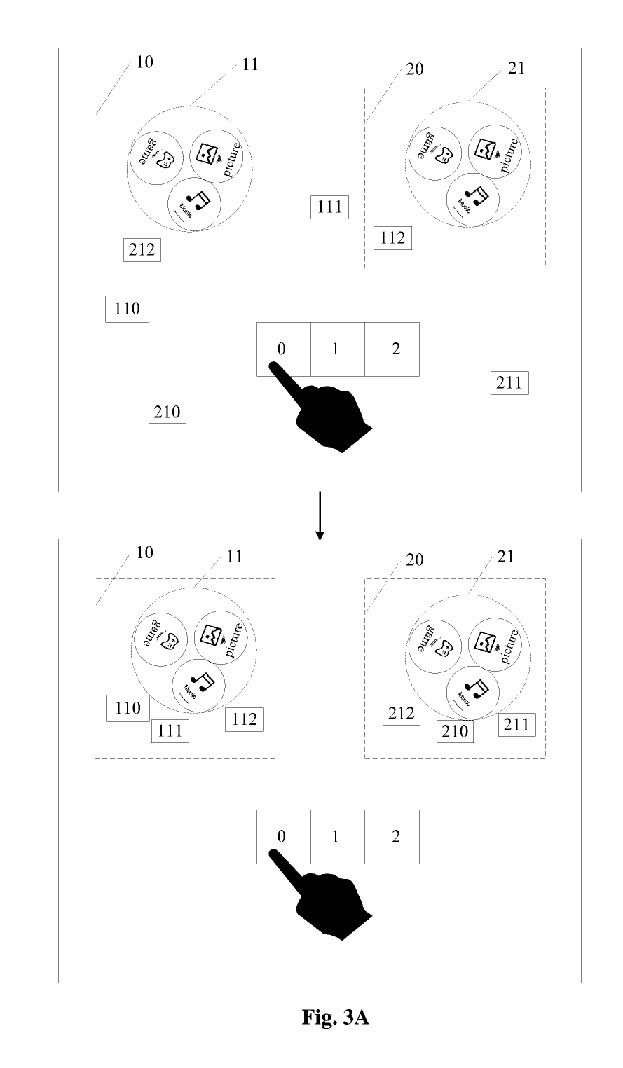

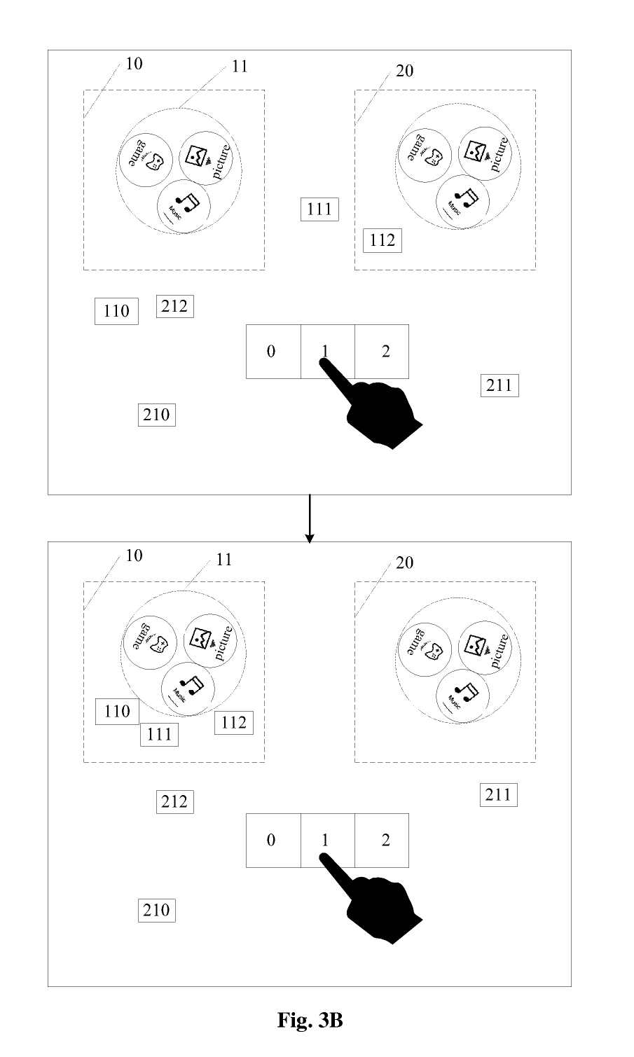

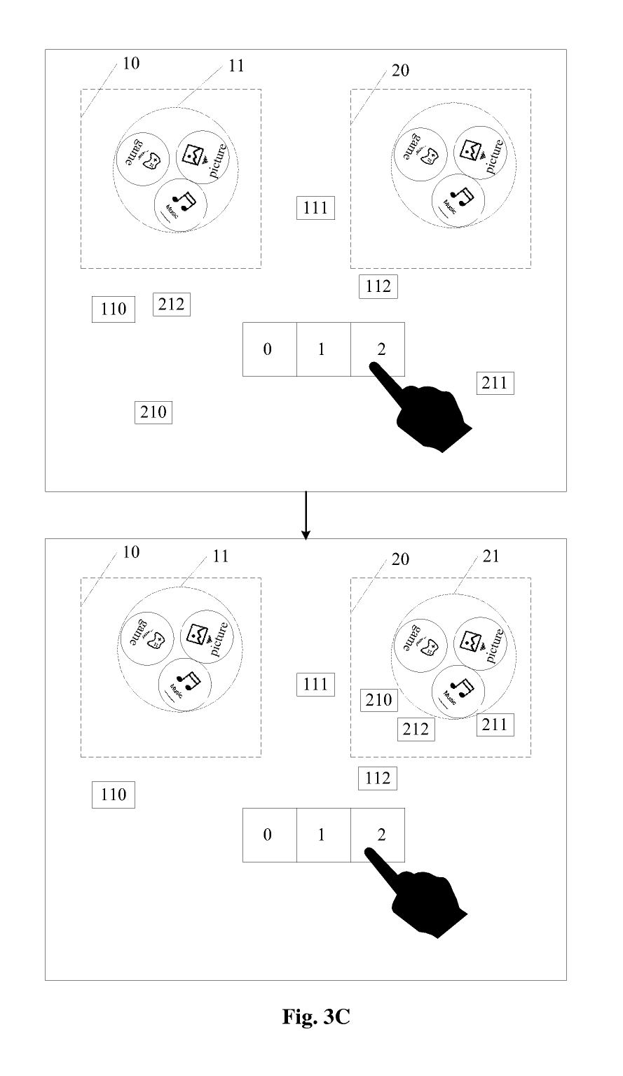

For example, referring to FIG. 3A, the first electronic is connected with the second electronic device, and two navigation menus are displayed on the first electronic device. A navigation menus 11 in a region 10 is a navigation menu for the first electronic device, and files 110, 111, 112 are files in the first electronic device. A navigation menu 21 in a region 20 is a navigation menu for the second electronic device, and files 210, 211, 212 are files in the second electronic device. A number pad is also displayed on the first electronic device, and numbers 0, 1, 2 are displayed on the number pad. The method includes:

judging whether the user clicks a number on the number pad;

adjusting, in the case that the user clicks a number 0 on the number pad, the display positions for the files 110, 111, 112, 210, 211, 212, to display the files 110, 111, 112 at the region 10, and display the files 210, 211, 212 at the region 20, as shown in FIG. 3A;

adjusting, in the case that the user clicks a number 1 on the number pad, the display positions for the files 110, 111, 112, to display the files 110, 111, 112 at the region 10, as shown in FIG. 3B; and

adjusting, in the case that the user clicks a number 2 on the number pad, the display positions for the files 210, 211, 212, to display files 210, 211, 212 at the region 20, as shown in FIG. 3C.

Optionally, before the step of displaying P files in the N files at one or more regions of the M regions corresponding to the P files, the N files are randomly displayed in respective regions on the display unit. That is to say, before the files are arranged, an operation of the user on N files, for example an operation of moving their required files to different positions by different users, results in that the N files on the display unit are in a disordered display state.

Optionally, after the step of displaying P files in the N files at one or more regions of the M regions corresponding to the P files, the method further includes: obtaining a second operation; judging whether the second operation is an operation for dragging the P files to one or more second display regions different from the one or more regions of the M regions; and moving the P files to display all of the P files at the second display regions, in the case that the second operation is the operation for dragging the P files to the one or more second display regions different from the one or more regions of the M regions.

The step of moving P files to display all of the P files at the second display regions, in the case that a second operation is the operation for dragging the P files to the one or more second display regions different from the one or more regions of the M regions may include the following three cases.

(1) In the case that the second operation is an operation for dragging the P files to one second display region different from one region of the M regions, the P files are moved to display all of the P files in the second display region.

Referring to FIG. 2C, the first electronic device is connected with the second electronic device and two navigation menus are displayed on the first electronic device. A navigation menu 11 in a region 10 is a navigation menu for the first electronic device, and files 110, 111, 112 are files in the first electronic device. A navigation menu 21 in a region 20 is a navigation file for the second electronic device, and files 210, 211, 212 are files in the second electronic device. When the user makes a dragging operation to a second display region 30 different from the region 20 with her or his finger, P files are determined as the files 210, 211, 212. Thus, the files 210, 211, 212 are moved into the second display region 30. Preferably, a file object corresponding to the P files, i.e., the navigation menu 21, is also dragged into the second display region 30.

(2) In the case that the second operation is an operation for dragging the P files to one second display region different from multiple regions of the M regions, the P files are moved to display all of the P files in the second display region.

Referring to FIG. 2D, the first electronic device is connected with the second electronic device, and two navigation menus are displayed on the first electronic device. A navigation menu 11 in a region 10 is a navigation menu for the first electronic device, and files 110, 111, 112 are files in the first electronic device. A navigation file 21 in a region 20 is a navigation menu for the second electronic device, and files 210, 211, 212 are files in the second electronic device. When the user makes a dragging operation from another region different from the regions 10 and 20 to a second display region 30 different from the regions 10 and 20 with a finger, P files are determined as the files 110, 111, 112, 210, 211 212. Thus, the files 110, 111, 112, 210, 211, 212 are all moved into the second display region 30. Preferably, file objects corresponding to the P files, i.e., the navigation menu 11 and the navigation menu 21 are also dragged into the second display region. In the embodiment, the second display region with the navigation menu 11 and files 110, 111, 112 is the same as the second display region with the navigation menu 21 and files 210, 211, 212.

(3) In the case that the second operation is an operation for dragging P files to multiple second display regions different from multiple regions of the M regions, the P files are moved to display all of the P files in the second display region.

Referring to FIG. 2E, the first electronic device is connected with the second electronic device, and two navigation menus are displayed on the first electronic device. A navigation menu 11 in a region 10 is a navigation menu for the first electronic device, and files 110, 111, 112 are files in the first electronic device. A navigation menu 21 in a region 20 is a navigation menu for the second electronic device, and files 210, 211, 212 are files in the second electronic device. When the user makes a dragging operation from other regions different from the regions 10 and 20 to a second display region different from the regions 10 and 20 with a finger, the P files are determined as the files 110, 111, 112, 210, 211 212. Thus, the files 110, 111, 112 are dragged into one second display region 301; and the files 210, 211, 212 are dragged into another second display region 302. Preferably, file objects corresponding to P files, i.e., the navigation file 11 and the navigation file 21 are respectively dragged into the corresponding second display region 301 and the corresponding second display region 302. In the embodiment, the second display region 301 with the navigation menu 11 and files 110, 111, 112 is different from the second display region 302 with the navigation menu 21 and files 210, 211, 212.

Furthermore, the first operation and the second operation are touch operations, an execution time for the first operation is a first period, and an execution time for the second operation is a second period. Each of the first period and the second period is successive. During a whole period of the first period or the second period, an operator who performs the first operation and the second operation keeps touching the display. For example, the user firstly presses on the touch display unit with a finger to makes the first operation conforming to the first preset condition, for example drawing a circle. Then, the electronic device starts an arranging function based on the first operation; meanwhile, fingers continue to contact the touch display unit. After the arranging function is started, the finger begins to move from a current position to complete a second operation. That is, the finger presses on a region of the touch display unit and draws a circle. After the circle is dawn, the arranging function is started. At this time, the finger does not lift but continue to perform a touch operation to complete the second operation.

Based on the detail description for the implementation of the information processing method in the embodiment, it is judged whether the first operation conforms to the first preset condition; in the case that the first operation conforms to the first preset condition, P files in the N files are displayed in one or more regions of the M regions corresponding to the P files. In this way, the operation for arranging files are simplified, steps of the operation for arranging files by the user are reduced, thereby improving operational efficiency and user experience.

### Second Embodiment

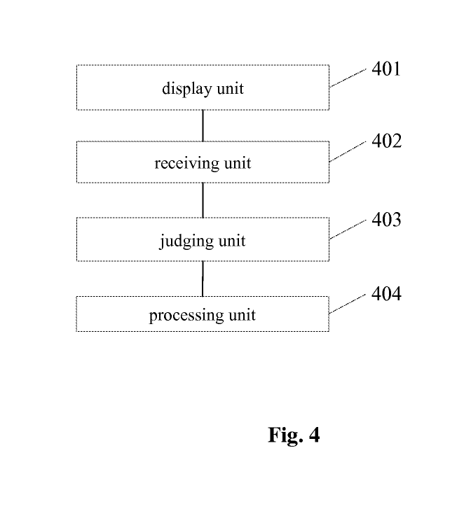

Based on the same concept, an embodiment of the disclosure further provides an electronic device. Referring to FIG. 4, the electronic device includes: a display unit 401 configured to display N files and M file objects, where the M file objects are respectively displayed in M regions of the display unit 401, and the N files correspond to the M file objects; a receiving unit 402 configured to receive a first operation by a first electronic device; a judging unit 403 configured to judge whether the first operation conforms to a first preset condition; and a processing unit 404 configured to display P files in the N files at one or more regions of the M regions corresponding to the P files, in the case that the first operation conforms to the first preset condition, where P is a positive integer less than or equal to N.

Optionally, the M file objects are obtained by receiving and caching storage locations of the M file objects in M second electronic devices by the first electronic device.

Optionally, before the processing unit 404 displays P files in the N files at one or more regions of the M regions corresponding to the P files, the N files are randomly displayed at respective regions of the display unit 401.

Optionally, the judging unit 403 is configured to judge whether the first operation is a preset operation and whether the electronic device receives the first operation in one of M regions. The processing unit 404 is configured to display W files in the P files at a region corresponding to the Q-th file object, in the case that the first operation is the preset operation and the first electronic device receives the first operation in the region corresponding to the Q-th file object of the M file objects, where W files correspond to the Q-th file object, W is a positive integer less than or equal to P, and Q is a positive integer less than or equal to M.

Optionally, the judging unit 403 is configured to judge whether the first operation is a preset operation and whether the electronic device receives the first operation at a first display region different from the M regions. The processing unit 404 is configured to display the P files at the M regions corresponding to the P files respectively, in the case that the first operation is the preset operation and the electronic device receives the first operation in the first display region different from the M regions, where P is equal to N.

Optionally, the receiving unit 402 is further configured to obtain a second operation. The judging unit 403 is further configured to judge whether the second operation is an operation for dragging P files to one or more second display regions different from the one or more regions of the M regions. The processing unit 404 is further configured to move P files to display all of the P files at the second display regions, in the case that the second operation is the operation for dragging the P files to the one or more second display regions different from the one or more regions of the M regions.

Optionally, the first operation and the second operation are touch operations, an execution time for the first operation is a first period, and an execution time for the second operation is a second period. Each of the first period and the second period is successive. During a whole period of the first period or the second period, an operator which performs the first operation or the second operation keeps touching the display unit 401.

The electronic device according to the second embodiment and the information processing method according to the embodiment described referring to the preceding FIG. 1 and the modified embodiments thereof are based on the same concept. According to the detail description for the information processing method described above and modified embodiments, those skilled in the art may clearly understand the implementing process for the electronic device in the embodiment, which is not described here for conciseness of the specification.

One or more embodiments in the above embodiments of the disclosure may at least achieve the following technical effects.

In an embodiment of the disclosure, N files and M file objects are displayed on the display unit. The first electronic device receives the first operation of the user, and judges whether the first operation conforms to the first preset condition. In the case that the first operation conforms to the first preset condition, P files in the N files are displayed at one or more regions of the M regions corresponding to the P files. In this way, the operation for arranging files are simplified, steps of the operation for arranging files by the user are reduced, thereby improving operational efficiency and user experience.

Those skilled in the art should understand that the embodiments of the disclosure may be implemented as a method, a system or a computer program product. Therefore, the disclosure may employ only hardware embodiments, only software embodiments or embodiments of a combination of software and hardware. Furthermore, the disclosure may employ computer program products implemented on one or more computer available storage mediums (including but not limiting to a magnetic disc memory, a CD-ROM, an optical memory) which contain computer available program codes.

The disclosure is described by referring to flow charts and/or block diagrams according to the methods, devices (systems) and computer program products of the embodiments of the disclosure. It should be understood that each flow and/or block of the flow charts and/or block diagrams and a combination of the flow and/or the block in the flow charts and/or the block diagrams may be implemented by computer program instructions. These computer program instructions may be provided to a general computer, a dedicated computer, an embedded processor or a processor of other programmable processing devices so as to generate a machine, such that the instructions executed by a computer or a processor of other programmable data processing devices generate an apparatus which is used to achieve the functions specified in one or more flows in the flow charts and/or one or more blocks in the block diagrams.

These computer program instructions may also be stored in a computer readable memory which can guide the computer or other programmable data processing devices to work in a specific way, such that the instructions stored in the computer readable memory generate products including the instruction apparatus, the instruction apparatus achieves the functions specified in one or more flows in the flow charts and/or one or more blocks in the block diagrams.

These computer program instructions may also be loaded to a computer or other programmable data processing devices, such that a series of operational steps are performed on the computer or other programmable devices to generate a process to be implemented by the computer, thereby instructions executed on the computer or other programmable devices provide steps for achieving functions specified in one or more flows in the flow charts and/or one or more blocks in the block diagrams.

Specifically, an information processing method provided by the embodiments of the disclosure is applied to a first electronic device. The first electronic device includes one display unit, N files and M file objects are displayed on the display unit. M file objects are respectively displayed in M regions of the display unit, and the N files correspond to the M file objects. Computer program instructions corresponding to the information processing method according to the embodiments of the disclosure may be stored in a storage medium such as a compact disc, a hard disc, a USB disc. Reading or executing computer program instructions in the storage medium corresponding to the information processing method by an electronic device includes the following steps:

receiving a first operation by the first electronic device;

judging whether the first operation conforms to a first preset condition; and

displaying P files in the N files at one or more regions of the M regions corresponding to the P files, in the case that the first operation conforms to the first preset condition, where P is a positive integer less than or equal to N.

Optionally, the M file objects are obtained by receiving and caching storage locations of the M file objects in M second electronic devices by the first electronic device.

Optionally, before the displaying P files in the N files at one or more regions of the M regions corresponding to the P files, the N files are randomly displayed in respective regions on the display unit.

Optionally, the storage medium also stores another computer instructions. During a process for specifically executing computer instructions corresponding to the step for judging whether the first operation conforms to the first preset condition, the process of executing those computer instructions include the following steps:

judging whether the first operation is a preset operation and whether the electronic device receives the first operation in one of the M regions.

The storage medium also stores other computer instructions. During a process for specifically executing computer instructions corresponding to the step for displaying P files in the N files at one or more regions of the M regions corresponding to the P files, in the case that the first operation conforms to the first preset condition, the process of executing those computer instructions include the following steps:

displaying W files in the P files at a region corresponding to the Q-th file object, in the case that the first operation is the preset operation and the first electronic device receives the first operation in the region corresponding to the Q-th file object of the M file objects, where the W files correspond to the Q-th file object, W is a positive integer less than or equal to P, and Q is a positive integer less than or equal to M.

Optionally, the storage medium also stores other computer instructions. During a process for specifically executing computer instructions corresponding to the step for judging whether the first operation conforms to the first preset condition, the process of executing those computer instructions include the following step:

judging whether the first operation is a preset operation and whether the electronic device receives the first operation at a first display region different from the M regions.

The storage medium also stores other computer instructions. During a process for specifically executing computer instructions corresponding to the step for displaying P files in the N files at one or more regions of the M regions corresponding to the P files in the case that the first operation conforms to the first preset condition, the process of executing those computer instructions include the following step:

displaying the P files at the M regions corresponding to the P files respectively in the case that the first operation is the preset operation and the electronic device receives the first operation at the first display region different from the M regions, where P is equal to N.

Optionally, the storage medium also stores other computer instructions. After computer instructions corresponding to the step for displaying P files in the N files at one or more regions of the M regions corresponding to the P files, the process of executing those computer instructions include the following steps:

obtaining a second operation;

judging whether the second operation is an operation for dragging the P files to one or more second display regions different from the one or more regions of the M regions; and

moving the P files to display all of the P files at the second display regions, in the case that the second operation is the operation for dragging the P files to the one or more second display regions different from the one or more regions of the M regions.

Optionally, the first operation and the second operation are touch operations, an execution time for the first operation is a first period, and an execution time for the second operation is a second period. Each of the first period and the second period are successive. During a whole period of the first period or the second period, an operator which performs the first operation or the second operation keeps touching the display unit.

Obviously, those skilled in the art may make various changes and variations to the disclosure without departing from the spirit and scope of the disclosure. In this way, if these changes and variations to the disclosure fall within the scope of the claims of the disclosure and its equivalent technology, the disclosure is intended to include these changes and variations.

1. An information processing method, applied to a first electronic device, wherein the first electronic device comprises a display unit, N files and M file objects are displayed at the display unit, the M file objects are respectively displayed in M regions of the display unit, the N files corresponds to the M file objects, and the method comprises:
receiving a first operation by the first electronic device;
judging whether the first operation conforms to a first preset condition; and
displaying P files in the N files at one or more regions of the M regions corresponding to the P files in the case that the first operation conforms to the first preset condition, wherein P is a positive integer less than or equal to N.

2. The method according to claim 1, wherein the M file objects are obtained by receiving and caching storage locations of the M file objects in M second electronic devices by the first electronic device.

3. The method according to claim 1, wherein before the displaying P files in the N files at one or more regions of the M regions corresponding to the P files, the N files are randomly displayed in respective regions on the display unit.

4. The method according to claim 1, wherein the judging whether the first operation conforms to a first preset condition comprises:
judging whether the first operation is a preset operation and whether the first electronic device receives the first operation in one of the M regions;
the displaying P files in the N files at one or more regions of the M regions corresponding to the P files in the case that the first operation conforms to the first preset condition comprises:
displaying W files in the P files at a region corresponding to the Q-th file object, in the case that the first operation is the preset operation and the first electronic device receives the first operation at a region corresponding to the Q-th file object of the M file objects; wherein the W files correspond to the Q-th file object, W is a positive integer less than or equal to P, and Q is a positive integer less than or equal to M.

5. The method according to claim 1, wherein the judging whether the first operation conforms to a first preset condition comprises:
judging whether the first operation is a preset operation and whether the first electronic device receives the first operation at a first display region different from the M regions;
the displaying P files in the N files at one or more regions of the M regions corresponding to the P files in the case that the first operation conforms to the first preset condition comprises:
displaying the P files at the M regions corresponding to the P files respectively in the case that the first operation is the preset operation and the first electronic device receives the first operation at the first display region different from the M regions, wherein P is equal to N.

6. The method according to claim 1, wherein after the displaying P files in the N files at one or more regions of the M regions corresponding to the P files, the method further comprises:
obtaining a second operation;
judging whether the second operation is an operation for dragging the P files to one or more second display regions different from the one or more regions of the M regions; and
moving the P files to display all of the P files at the second display regions, in the case that the second operation is the operation for dragging the P files to the one or more second display regions different from the one or more regions of the M regions.

7. The method according to claim 6, wherein the first operation and the second operation are touch operations, an execution time for the first operation is a first period, an execution time for the second operation is a second period, each of the first period and the second period is successive, and during a whole period of the first period or the second period, an operator which performs the first operation or the second operation keeps touching the display unit.

8. An electronic device, comprising:
a display unit configured to display N files and M file objects, wherein the M file objects are respectively displayed in M regions of the display unit, the N files correspond to the M file objects;
a receiving unit configured to receive a first operation by the electronic device;
a judging unit configured to judge whether the first operation conforms to a first preset condition; and
a processing unit configured to display P files in the N files at one or more regions of the M regions corresponding to the P files in the case that the first operation conforms to the first preset condition, wherein P is a positive integer less than or equal to N.

9. The electronic device according to claim 8, wherein the M file objects are obtained by receiving and caching storage locations of the M file objects in M second electronic devices by the first electronic device.

10. The electronic device according to claim 8, wherein before the processing unit displays the P files in the N files at one or more regions of the M regions corresponding to the P files, the N files are randomly displayed in respective regions on the display unit.

11. The electronic device according to claim 8, wherein
the judging unit is configured to:
judge whether the first operation is a preset operation and whether the electronic device receives the first operation at one of the M regions;
the processing unit is configured to:
display W files in the P files at a region corresponding to the Q-th file object, in the case that the first operation is the preset operation and the first electronic device receives the first operation at a region corresponding to the Q-th file object of the M file objects; wherein the W files correspond to the Q-th file object, W is a positive integer less than or equal to P, and Q is a positive integer less than or equal to M.

12. The electronic device according to claim 8, wherein
the judging unit is configured to:
judge whether the first operation is a preset operation and whether the electronic device receives the first operation at a first display region different from the M regions;
the processing unit is configured to:
display the P files at the M regions corresponding to the P files respectively, in the case that the first operation is the preset operation and the electronic device receives the first operation at the first display region different from the M regions, wherein P is equal to N.

13. The electronic device according to claim 8, wherein
the receiving unit is further configured to:
obtain a second operation;
the judging unit is further configured to:
judge whether the second operation is an operation for dragging the P files to one or more second display regions different from the one or more regions of the M regions; and
the processing unit is further configured to:
move the P files to display all of the P files at the second display regions, in the case that the second operation is the operation for dragging the P files to one or more second display regions different from the one or more regions of the M regions.

14. The electronic device according to claim 13, wherein the first operation and the second operation are touch operations, an execution time for the first operation is a first period, an execution time for the second operation is a second period, each of the first period and the second period is successive, and during a whole period of the first period or the second period, an operator which performs the first operation or the second operation keep touching the display unit.
